(19) United States
(12) Patent Application Publication
(10) Pub. No.: US 2025/0187836 A1
(43) Pub. Date: Jun. 12, 2025

(54) Process for Redistributing Packages in a Sorting Station

(71) Applicant: Deutsche Post AG, Bonn (DE)

(72) Inventors: Frank Langer, Troisdorf (DE); Florian Felten, Wachtberg (DE)

(21) Appl. No.: 18/970,385

(22) Filed: Dec. 5, 2024

(30) Foreign Application Priority Data
Dec. 7, 2023 (DE) 10 2023 134 278.9

(51) Int. Cl. B65G 1/137; B65G 43/08

(52) U.S. Cl. CPC B65G 1/1378; B65G 43/08; B65G 2201/02; B65G 2203/0208

(57) ABSTRACT

A method for redistributing packages in a sorting station is described and illustrated. In order to enable a further increased efficiency of sorting stations with reasonable effort, it is provided that the packages are scanned successively in at least one transport sequence in order to respectively detect at least one sorting parameter in accordance with the at least one transport sequence, that the scanned packages are sorted in the at least one transport sequence in a sorting device on the basis of the at least one sorting parameter and are divided into at least two parallel sorting sequences of packages, that the packages of the parallel sorting sequences are loaded one after the other into at least one transport unit with at least one common robot in accordance with the sorting parameters, that a control device determines an optimized loading sequence for the at least one common robot based on the at least one sorting parameter of the packages of the at least two parallel sorting sequences and, preferably, based on at least one loading state of the at least one transport unit, and that the packages are loaded into the at least one transport unit by the at least one common robot in accordance with the optimized loading sequence.

### CROSS-REFERENCE TO RELATED APPLICATION

This application claims priority to German Patent Application No. 10 2023 134 278.9 filed Dec. 7, 2023, the disclosure of which is hereby incorporated by reference in its entirety.

### BACKGROUND OF THE INVENTION

### Field of the Invention

The invention relates to a method for redistributing packages in a sorting station.

Methods for redistributing packages in sorting stations are known in various configurations. In principle, in many of these methods, packages are fed to the sorting station in a bundled manner of transport units, which may be bodies of trucks or trailers, for example. These transport units are then unloaded and transferred individually to a conveyor belt. The packages can then be scanned, whereby a sorting parameter is recorded according to which the packages are sorted. Depending on the sorting parameter, the packages are then distributed to different transport units, which are then used to transport the packages away from the sorting station. In many cases, these transport units, unlike the transport units that are unloaded in the sorting station, are roll containers, mesh boxes, pallets, pallets with walls or unit load devices (ULD). Unit load devices are pallets and containers that are used to load aircrafts and are therefore adapted to the dimensions of aircraft fuselages.

After scanning, the packages can be temporarily stored in a temporary storage, such as a rack storage system or similar, until they are transported onwards. The packages can then be removed from the temporary storage in a specific or in any order. However, in order to achieve high efficiency and a short dwell time of the packages in the sorting station, intermediate storage of the packages is often dispensed with. The packages are conveyed by conveyor belts or similar from the place of unloading from transport units to the place of loading into other transport units and sorted in the process. It is conceivable, for example, that some of the packages are moved from one conveyor belt to another conveyor belt or into a chute in order to sort the packages. If required, there is then a transport sequence in which the packages are transported, scanned and fed to a sorting device. After sorting, the packages form at least two sorting sequences. Each sorting sequence typically contains packages with a different sorting parameter. Each sorting sequence is fed to different transport units, into which the packages are placed by a robot as required.

### Description of Related Art

In order to make efficient use of the space available in the transport units, the dimensions of the packages are also recorded in some cases. A loading algorithm can then specify where certain packages should be stacked in the transport units in order to waste little space. Supportingly, sensors can also be used to monitor the current loading situation of the transport units. If the packages are temporarily stored in the sorting station, the packages can be removed from the temporary storage in a sequence in which they can be stacked in a save spacing manner.

Loading transport units with sorted packages in sorting stations with the help of robots does not achieve satisfactory efficiency despite the technical aids. In many cases, manual loading is faster and more accurate. However, manual loading does not allow automation. In other cases, still a lot of space is wasted in the transport units despite the high technical effort involved in loading.

### SUMMARY OF THE INVENTION

Therefore, the present invention is based on the object of designing and further developing the method of the type mentioned at the beginning and explained in more detail above in such a way that the efficiency of sorting stations can be further increased at a reasonable cost.

This task is solved as described herein by a method for redistributing packages in a sorting station,
in which the packages (2) are scanned successively in at least one transport sequence (4) in order to respectively detect at least one sorting parameter in accordance with the at least one transport sequence (4),
in which the scanned packages (2) are sorted in the at least one transport sequence (4) in a sorting device (6) on the basis of the at least one sorting parameter and are divided into at least two parallel sorting sequences (10) of packages (2),
in which the packages (2) of the parallel sorting sequences (10) are loaded one after the other into at least one transport unit (12) with at least one common robot (11) in accordance with the sorting parameters,
in which a control device (6) determines an optimized loading sequence for the at least one common robot (11) based on the at least one sorting parameter of the packages (2) of the at least two parallel sorting sequences (10) and, preferably, based on at least one loading state of the at least one transport unit (12), and
in which the packages (2) are loaded into the at least one transport unit (12) by the at least one common robot (11) in accordance with the optimized loading sequence.

According to the method, the packages can be unloaded from a transport unit and then transferred in a transport sequence, for example if a delivery of packages transported to a sorting station by a transport unit needs to be redistributed and sorted. Redistributing can mean that the packages from one transport unit are distributed to different transport units. However, this does not have to be the case. The transport sequence can be formed independently of the delivery of the packages in a common transport unit. It is also conceivable, for example, that the packages from one transport unit are merely repacked in a different sequence or arrangement in another transport unit or that the transport sequence is formed from packages temporarily stored in the sorting station.

The packages of at least one given transport sequence are scanned in order to determine in this way, one after the other, at least one sorting parameter of the packages in the transport sequence. The scanned packages of the transport sequence can then be sorted in a sorting device using the at least one sorting parameter of the packages, wherein the sorting is performed in such a way that the packages of the transport sequence are divided into at least two parallel sorting sequences of packages. The parallel sorting sequences are not used to load the packages of one sorting sequence into at least one transport unit and the packages of another sorting sequence into at least one other transport unit. Rather, the packages of the parallel sorting sequences are loaded one after the other into at least one transport unit in accordance with the sorting parameters using at least one common robot. Through loading, a transport unit or a series of transport units is created into which packages from different sorting sequences have been loaded by the at least one common robot. The sorting sequences are preferably generated in the sorting device from separate conveyor belts, which can transport the packages to the at least one common robot.

To ensure that loading takes place effectively and/or according to desired specifications, the loading is controlled by a control device which has knowledge of the sorting parameters of the packages and the arrangement of the packages in the at least two parallel sorting sequences. For example, the at least one sorting parameter of the packages of the transport sequence can be transmitted to the sorting device, so that the control device can control the sorting of the packages and generates sequences of packages in the sorting sequences known to the control device, wherein the packages of the transport sequence are assigned by the control device to a sorting sequence of the at least two sorting sequences respectively on the basis of the at least one sorting parameter.

The control device can, while taking into account the sorting parameters of the packages of the at least two parallel sorting sequences and the arrangement of the packages in the sorting sequences, determine in which loading sequence the packages of the sorting sequences should be loaded into the at least one transport unit by at least one common robot. A common robot is understood to be a robot that can remove packages from the at least two parallel sorting sequences. This can always involve the frontmost packages in the sorting sequences. However, it is also conceivable that the common robot can remove certain packages from the sorting sequences for loading that are not the frontmost packages in the sorting sequences. For this purpose, for example, the common robot can be moved along the sorting sequences and/or the sorting sequences can be moved along the at least one common robot. In such a case, the robot can select very flexibly from many different packages of each or certain sorting sequences for loading.

As the at least one common robot can select from the packages in the parallel sorting sequences, the loading sequence can be easily optimized. Hereby, optimized does not necessarily mean that an optimum is achieved. It is sufficient if the loading sequence can be markedly improved in this way. To support this, in a preferred embodiment of the method, a loading state of at least one transport unit can also be taken into account when generating an optimized loading sequence for the at least one common robot. Ultimately, the packages are then loaded into the at least one transport unit by the at least one common robot in accordance with the optimized loading sequence. This allows the packages to be loaded into the transport units in a space-saving and/or damage-free manner, for example, if the control device optimizes the loading sequence of the packages based on the sorting parameters of the packages in this regard. This can increase the efficiency of both the sorting station and the process for redistributing packages in a sorting station without requiring disproportionate effort.

The packages can be delivered to the sorting station bundled in separate transport units, which may, for example, be truck bodies or trailers. The packages are typically stacked and thereby form a bundle of packages in which the packages are not in any particular order. The transport units can then be unloaded in the sorting station, with several transport units preferably being unloaded one after the other. However, this does not rule out the possibility of unloading separate transport units in parallel to one another. During unloading, the packages are separated and guided past a scanning device, for example by at least one conveyor belt, one after the other in at least one transport sequence. The packages transported to the scanning device in the at least one transport unit are scanned, with at least one size dimension and one sorting parameter of the packages being recorded respectively.

The subsequent sorting of the packages takes place on the basis of this at least one sorting parameter. The sorting parameter can, for example, contain destination information as to where the respective package is to be transported, such as a zip code or similar. Packages with the same sorting parameters do not necessarily have to be grouped together during sorting. Packages with sorting parameters that lie within a predefined range of values, such as postal code ranges, can also be grouped together. By sorting the packages in the sorting device, the transport sequence of the packages is divided into at least two separate sorting sequences of packages. Depending on the number of criteria used for sorting, more or less separate sorting sequences are produced during sorting.

The packages of the different sorting sequences are loaded into common transport units, whereby they can be mixed together again. The packages are loaded according to the respective loading sequence specified by the control unit. The robot therefore loads the packages one after the other in the loading sequence. The more parallel sorting sequences are generated for the at least one common robot from the transport sequence of packages, the more practical the loading sequence can be. When a transport unit has been loaded in the manner described, a further transport unit can then be loaded in the same way, for example until all the packages in the transport sequence have been loaded into transport units.

Packages can generally be understood to mean piece goods of different types. However, it can also mean piece goods of a particular type, such as goods packed in packages. Packages can therefore have at least one outer packaging made of paper, cardboard, fabric or plastic and can be in the form of parcels, boxes and containers, for example, as well as non-stable containers such as bags, pouches or sacks. The goods packed in packages can themselves be individual piece goods, bulk goods, liquids or paste-like materials.

In a first, particularly preferred embodiment of the method, the packages are loaded by a respective at least one common robot from separate parallel sorting sequences successively into a respective at least one different transport unit in accordance with the sorting parameters of the packages of the respective separate parallel sorting sequences. The process can therefore be extended by generating several parallel sorting sequences in the sorting device. At least one robot is then respectively assigned to the different parallel sorting sequences, with one of the robots loading packages from certain parallel sorting sequences and another robot loading packages from other parallel sorting sequences. Put simply, the process described above can be duplicated or multiplied in this way, which can lead to higher throughput and greater efficiency.

In order to further optimize the loading of the transport units, it can be useful if the loading status of the at least one transport unit is determined during the loading of the packages by means of at least one sensor, in particular an optical sensor, and passed to the control device to optimize the loading sequence. For example, whether a particular package can still be loaded into a particular free space in the transport unit or whether it would be better to load another package into the free space can be determined based on the determined loading status. The other package may, for instance in contrast to the one package, fit into the free space. However, if necessary, the other package can also fill the free space better than the one package. This ensures a fairly tight packing of packages in the transport unit. However, by monitoring the loading status, it is also possible to determine whether the transport unit is already almost fully loaded, so that packages can still be loaded that could easily be damaged if they were placed further down in the transport unit.

The at least one sorting parameter can be recorded by means of a suitable, in particular optical, scanning device. In order to be able to scan certain sorting parameters easily, quickly and reliably, it can be useful if the at least one sorting parameter of the packages is scanned using a six-sided scanner and/or a line scanner, in particular an RGB line scanner and/or a volume scanner. The six-sided scanner scans the packages respectively from all six spatial directions so that the actual dimensions can be recorded very accurately. The more precisely the dimensions are known, the more effectively the sorting sequences can be optimized. In principle, scanners of the types mentioned are known from similar applications. Six-sided scanners also make it possible to reliably capture sorting parameters such as zip codes or other printed information.

A six-sided scanner can preferably take an image of all six sides of the package, whereby the pixels of the images can then be evaluated. For example, the pixels belonging to a package can be counted and the size dimensions of the package can be determined from this, especially if a calibration has previously been carried out with regard to the ratio of pixel numbers and size dimensions. In a simpler case, a line scanner can also be used, past which the packages are transported. The line scanner scans one side of the package, for example from above, and captures images line by line. The pixels of each line can then be plotted against time or the number of lines in succession, resulting in images from a large number of individual lines and thus ultimately pixel areas that correlate with the size dimensions of the packages. After a corresponding calibration, the pixel area can be assigned to the size of the package from the corresponding viewing direction. RGB scanners are particularly preferred in this context, whereby RGB refers to a color space that is formed using the colors red, green and blue, i.e. the primary colors of light. Put simply, the line scanner captures the colors red, green and blue. In contrast to line scanners, six-sided scanners allow the volume or three-dimensional shape of the package to be determined. However, volume scanners, which usually use lasers, can also be used as an alternative or in addition. The volume scanners can also be formed as line scanners, which the packages are then transported past. The advantage of these scanners is that the three-dimensional shape of the packages can be deduced from a point roll of the laser captured by a corresponding detector. Typically, the side of a package lying on a conveyor belt is not scanned, but this can regularly be accepted. In most cases, the packages are exposed to the laser from one side, in particular at least essentially from above.

When using a six-sided scanner, a volume scanner, a line scanner, in particular an RGB line scanner, and/or other suitable scanning devices, it is advisable to scan at least two, in particular at least three, size parameters of each package. These can be the height, width and/or length of the packages. In some cases, it may also be preferable to specifically record the maximum height, the maximum width and/or the maximum length of the packages. If the dimensions are known in several dimensions, the control device can more reliably calculate an actual space-saving loading. This leads to better optimized sorting sequences of the packages for loading into the transport units, which is especially true if the packages can have very different dimensions.

In addition to scanning size measurements in the form of pure dimensions, it may also be possible to scan the shape and/or surface of the packages. This is particularly useful if the packages are not or not always cuboid or very thin or very flexible. In the case of packages that are not cuboid, a different relative arrangement to each other can be more space-saving than with cuboid packages of approximately the same size. If the shape and/or the surface of the packages is known to the control device, the control device can use the scanned shape and/or the surface of the packages to determine whether the shape is at least one predetermined special shape of the packages.

The control device can specify the handling of the special shapes according to criteria other than purely the size dimensions and/or the sorting parameters. A surface is preferably scanned by capturing an image of at least one surface. For example, at least one image from a six-sided scanner or at least one image of the surface composed from lines by a line scanner can be used here. An evaluation of the surface can then be carried out using the color gradients or gray value distributions, for example.

For example, it can be specified that certain special shapes are removed from the sequence of packages. The special shapes can then be removed from the, in particular provisional, transport sequence and/or from the, in particular provisional, sorting sequence. Removal after the sorting device requires longer transportation in the sorting station. However, the special shape has then been sorted according to the at least one sorting parameter, which can be useful for further handling of the packages. The packages with the special shapes can be loaded into different transport units than the packages that do not have the at least one special shape. These may be separate transport units that are only intended for loading special shapes. Alternatively or additionally, the special shapes can be provided for manual loading. Loading into transport units is then not carried out by a robot. In this context, special shapes that cannot be handled or loaded by a robot, or can only be handled or loaded with difficulty, can be considered. The at least one robot present is therefore not blocked by such packages with special shapes. In this case, packages with special shapes do not even reach the robot and are loaded manually elsewhere. Alternatively or additionally, packages with certain special shapes can also be combined into separate sorting sequences.

The control device can, based on the at least one size parameter, the shape and/or the surface of the packages, determine whether the shape is at least one predetermined special shape of the packages or not. If it is a special shape of the packages that has been previously defined using size parameters, shapes and/or surfaces, the packages with special shapes can be sorted into separate sorting sequences. This offers the advantage that certain special shapes can be loaded in a respective preferred manner. For example, particularly large and bulky packages are loaded further down in the transport unit rather than further up. This also applies in principle to particularly heavy packages. Particularly fragile packages, on the other hand, are better placed further up in the transport unit than further down. Particularly shaped packages may be conveniently placed next to each other in the transport unit, while packages with other shapes are positioned at certain points in the transport unit, for example in corners of the transport unit.

In order to enable space-saving loading of the transport units or to distinguish very reliably between different article classes of the packages, it can be useful if the control device generates electronic 3D models of the packages based on the at least one size parameter, the shape and/or the surface of the packages. These advantages can be used particularly effectively if the control device assigns the packages to different sorting sequences, at least also on the basis of the electronic 3D models of the packages. Packages with similar 3D models can therefore be grouped together in the sorting sequences as required.

For the sorting or the loading sequences, it can also be useful if the weight of the packages is known. Therefore, the at least one sorting parameter of the packages is preferably at least one weight of the packages. The weight can be recorded at the same time as scanning other sorting parameters. However, weighing and scanning of other sorting parameters can also take place one after the other. If the weight is known, packages in certain weight classes can be sorted in separate sorting sequences. However, this is not mandatory. It may be sufficient if the weights of the packages are known in order to determine a suitable loading sequence.

If at least one size parameter, the shape, the surface and/or the weight of the packages is known, the control device can, based on the at least one sorting parameter of the packages, infer the article classes of the packages. For example, parcels, bags, envelopes and pockets can represent different article classes. If assignments of the packages to different article classes are known, the packages can also be assigned to different sorting sequences by the control device, at least on the basis of the article classes of the packages.

Independently of this, at least one article class of the packages may comprise packages that cannot be handled by the at least one common robot. These packages may be those that are too large, not correctly shaped, too heavy and/or not stiff enough. In this case, at least one sorting sequence can include packages of such an article class as required, in particular exclusively. The corresponding sorting sequence can then be loaded manually into at least one transport unit as required.

In order to arrange the packages in the at least one transport unit in a particularly suitable manner, it is advisable for the common robot to remove packages from different sorting sequences of the at least two parallel sorting sequences one after the other and load them into the transport unit one after the other in the corresponding manner. This is possible particularly easily and quickly if the common robot removes the frontmost packages from each of the sorting sequences. However, this is not necessary if the common robot can also remove other than the last packages from the associated parallel sorting sequences, so there is significantly greater flexibility when loading the at least one transport unit. As a result, an even more suitable loading sequence can be generated. The flexibility for loading by the at least one common robot can alternatively or additionally be increased by always loading several transport units by the at least one common robot. A package that could not be loaded into one transport unit, or could only be loaded into one transport unit to a limited extent, can be loaded into another transport unit much more expediently if required. The robot can therefore not only select a suitable package for the next loading sequence, but also a suitable transport unit for loading the next package. Irrespective of this, it is advisable for the loading sequence to be specified by the control device using the at least one sorting parameter and the at least two parallel sorting sequences. Alternatively or additionally, the control device can use the at least one sorting parameter and the at least two parallel sorting sequences to specify which package in the loading sequence is loaded into which of several transport units.

For an efficient and practical method, it can be useful if the control device specifies the loading sequence of the packages at least partially with regard to space-saving loading of the packages into the at least one transport unit. This prevents an excessive amount of unused space remaining in the transport units, which could have accommodated further packages if a different loading sequence had been used.

Irrespective of this, it may be advisable for protection of the packages if the control device specifies the loading sequence of the packages at least partially with regard to the stackability of the packages in the at least one transport unit. The stackability can also take into account space-saving loading of the packages, but in particular the stackability of the packages can be estimated by the control device on the basis of the weight, dimensional stability and/or resistance of the packages. The stackability can therefore be estimated simply and appropriately by the control device based on the at least one sorting parameter.

The advantages of the method described can be utilized in a particularly practical manner if the packages are unloaded from transport units in the form of utility vehicle superstructures, preferably box bodies, in particular a truck, trailer or semi-trailer. Alternatively or additionally, it may also be possible for the packages to be unloaded from transport units in the form of non-self-propelled low-floor vehicles, in particular in the form of trolleys, pallet cages or unit load devices (ULD). In such processes, many large packages are distributed in a very short time, which is why optimizing the space in the transport units is both desirable and difficult.

Alternatively or additionally, it is preferable for the same reasons if the packages are loaded into non-self-propelled low-floor vehicles, in particular in the form of trolleys, pallet cages or unit load devices (ULD). Unit load devices are pallets and containers that are used to load aircrafts and are therefore adapted to the dimensions of aircraft fuselages.

With regard to the packages, the method described is suitable if the packages are packaged piece goods, in particular piece goods wrapped in a cardboard box. It is particularly useful if the piece goods are packages, bags, envelopes, pouches and/or bags. These packages are to be sorted and distributed in large numbers and with a short dwell time in sorting systems.

### BRIEF DESCRIPTION OF THE DRAWINGS

The invention is explained in more detail below with the aid of a drawing showing merely an embodiment. The drawing shows

FIG. 1 a top view of a sorting station for redistributing packages according to the invention, and

FIG. 2: the loading of packages in an optimized loading sequence with a robot of the sorting station from FIG. 1 in a side view.

### DESCRIPTION OF THE INVENTION

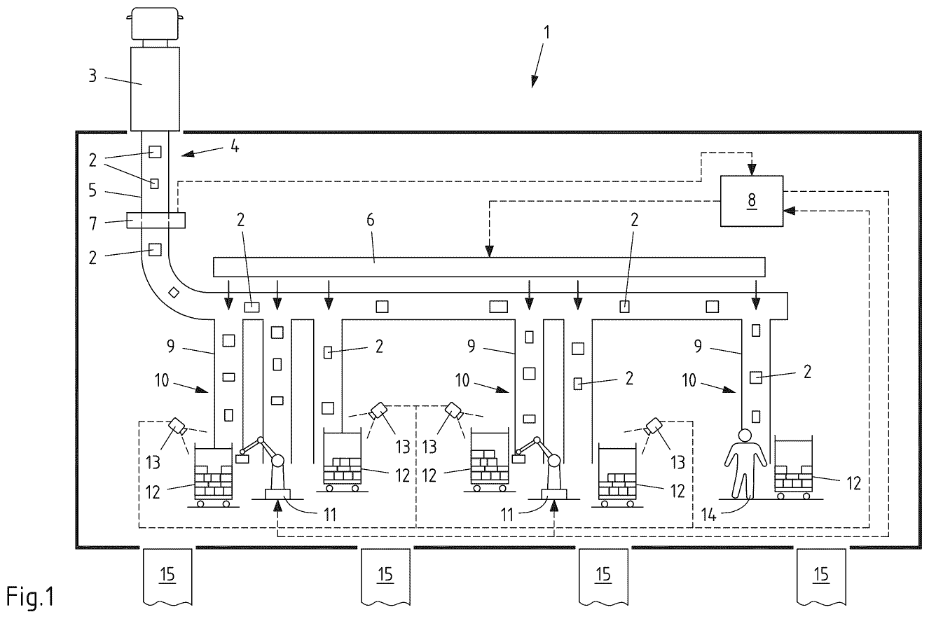

FIG. 1 shows a sorting station 1 for redistributing packages 2. The packages 2 can be, for example, piece goods, parcels, envelopes, bags and/or sacks. The packages 2 are transported to the sorting station 1 by transport units 3 in the form of utility vehicles, in particular trucks, trailers and/or semi-trailers, whereby the packages 2 are located in the superstructures of the utility vehicles. Once at the sorting station 1, the packages 2 are unloaded and singulated. In the preferred method shown, a single transport sequence 4 of packages 2 is generated from the unloaded packages 2. The transport sequence 4 is transported, in particular at least substantially continuously, by at least one conveyor belt 5 through the sorting station 1 to a sorting device 6. If necessary, several transport sequences 4 can also be generated, which can then be handled in parallel in the sorting station 1.

The transport sequence 4 of the packages 2 is fed to a scanning device 7, in which at least one sorting parameter, in particular a zip code and a size dimension, is recorded for each package 2. The weight, shape and surface of the packages 2 are also recorded. However, this is not mandatory. In the preferred method shown, the packages 2 are transported through a six-sided scanner of the scanning device 7, whereby the packages 2 are scanned from all six sides. Target information such as a zip code is read out, which is relevant as a sorting parameter for the subsequent sorting of the packages 2. The size dimensions length, height and width, as well as the shape and surface of the packages 2 are also recorded. In addition, the weight of the packages 2 is determined as they pass through the scanning device 7, if this appears appropriate.

The sequence of the packages 2, the sorting parameters assigned to the packages 2, the size dimensions, the shapes, surfaces and weights are transmitted to a control device 8. The packages 2 are transported from the scanning device 7 to the sorting device 6, where the packages 2 are distributed to different conveyor belts 9 according to the sorting parameters and arranged there in sorting sequences 10. This is controlled by the control device 8 using the transport sequence 4 of the packages 2 and the sorting parameters assigned to the packages 2. To sort the packages 2, they can first be transferred to rockers according to the transport sequence 4, which transport the packages 2 past the other conveyor belts 9 and tilt the packages 2 onto the conveyor belts 9 assigned to the sorting parameters according to the sorting parameters. Alternatively, the packages 2 can also be actively moved from the sorting device 6 to the conveyor belts 9 assigned to the sorting parameter. Other types of sorting are also possible and known. On the conveyor belts 9 adjoining the sorting device 6, sorting sequences 10 of the packages 2 are formed, which result from the transport sequence 4 of the packages 2 upstream of the sorting device 6 and the assignment of the sorting parameters to the packages 2 of the transport sequence 4.

The sorting sequences 10 are fed to different robots 11, to which respectively at least the foremost packages 2 of the sorting sequences 10 are accessible. The two robots 11 shown and preferred in this respect are each assigned to other conveyor belts 9 and sorting sequences 10, with each robot 11 being assigned several sorting sequences 10. Each robot 11 removes packages 2 from the sorting sequences 10 assigned to it one after the other and transfers them to the transport units 12 assigned to the respective robots 11. The transport units 12 are thus loaded in a loading sequence of packages 2, the packages 2 of the loading sequence being determined upstream of the control device 8 on the basis of the at least one sorting parameter of the packages 2 of the parallel sorting sequences 10 assigned to the robot 11 and on the basis of the loading state of the assigned transport units 12, in order to improve or optimize the loading of the transport units 12 as far as possible.

The control device 8 specifies the loading sequence of the packages 2 in the illustrated and insofar preferred method at least in part with regard to space-saving loading of the packages 2 into the transport units 12. The loading sequence of the packages 2 is also predetermined at least in part with regard to the stackability of the packages 2 in the at least one transport unit 12. The stackability of the packages 2 is estimated by the control device 8 on the basis of the weight, the dimensional stability and/or the durability of the packages 2, in particular on the basis of the at least one sorting parameter.

When determining the loading sequence, the control unit 8 has a high degree of flexibility and variation options at its disposal. The robots 11 can remove packages 2 from different sorting sequences 10 and there respectively from different positions within the sorting sequences 10. In addition, the robots 11 can load the individual packages 2 into different transport units 12. The control device 8 makes use of this flexibility in such a way that the loading space in the transport units 12 is utilized appropriately and that sensitive or fragile packages 2 are loaded as high as possible and large and heavy packages 2 are loaded as low as possible in the transport units 12.

It is not shown that the conveyor belts 9 for transporting the sorting sequences 10 can be designed as telescopic conveyor belts. These can then be extended and retracted in order to offer the assigned robot 11 the next suitable packages 2. Alternatively or additionally, however, the robot 11 itself can also be spatially adjustable in order to always be able to load the desired transport unit 12 in a suitable manner and/or remove packages 2 from different positions of the sorting sequences 10.

In the sorting station 1 shown and preferred in this respect, the packages 2 of the transport sequence 4 are sorted in the sorting device 6 into six different sorting sequences 10, a respective of the sorting sequences 10 being arranged on a conveyor belt 9 in order to be transported by the conveyor belt 9 in the direction of a robot 11. Three parallel sorting sequences 10 are assigned to the robot 11 shown on the left. The packages 2 of these three sorting sequences 10 are loaded one after the other by the common robot 11 into a plurality of transport units 12, whereby on the one hand space is saved in the transport units 12 wherever possible and on the other hand the packages 2 are stacked in the transport units 12 in such a way that they are not damaged by packages 2 stacked on top of them. The next two parallel sorting sequences 10 are assigned to a further robot 11, which removes the packages 2 from these sorting sequences 10 and stacks them in other transport units 12. Here too, an attempt is made to achieve space-saving stacking and to avoid damaging packages 2.

In the sorting sequence 10 shown on the right, the sorting device 6 groups together those packages 2 that cannot be loaded or cannot be loaded reliably into a transport unit 12 by a robot 11. The packages 2 may, for example, be so unstable or fragile that a robot 11 would probably damage the packages 2. Alternatively or additionally, the packages 2 may also be so large and/or so shaped that they cannot be reliably gripped by a robot 11. The packages 2 of the sorting sequence 10 shown on the right are therefore loaded by hand by a person 14 into at least one transport unit 12. The transport units 12 loaded by the person 14 and/or by the robots 11 are loaded into utility vehicles 15 in the sorting station 1 shown and preferred in this respect and transported away from the sorting station 1 by means of the utility vehicles 15.

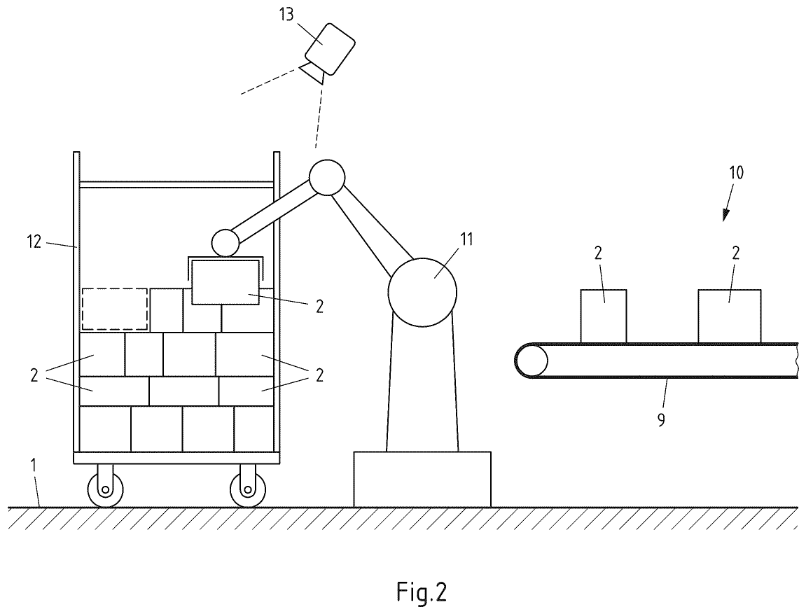

For example, the packages 2 are loaded into transport units by robots 11 according to the loading sequence of the packages 2 as shown in FIG. 2. In the illustrated and insofar preferred method, the transport units 12 are configured in the form of trolleys, which in turn can then be loaded into superstructures of utility vehicles such as trucks, trailers or semi-trailers. The control device 8 instructs the robots 11 where to place the packages 2 in the transport units 12 in order to make good use of the loading capacity of the transport units 12. This is shown schematically by the gap in the transport unit 12 highlighted by a dashed line for inserting the next package 2. Unused spaces in the transport units 12 between the packages 2 should be avoided or reduced as far as possible. The transport units 12 are each assigned sensors 13, in particular optical sensors, which detect the current loading status and transmit this to the control device 8. If necessary, the sensors 13 can also only forward images of the transport units 12, from which the control device 8 then determines the current loading status.

Additionally or alternatively, the loading sequence can be selected by the control device 8, taking into account the current loading state of transport units 12, so that more robust and specifically heavier packages 2 are loaded in the lower area of the transport units 12 and specifically lighter and more fragile packages 2 are loaded in the upper area of the transport units 12. The lighter and more fragile packages 2 are then not damaged or crushed by the more robust and heavier packages 2, since the more robust and heavier packages 2 are arranged below the lighter and more fragile packages 2 in the transport units.

### LIST OF REFERENCE SYMBOLS

1 sorting station
2 package
3 transport unit
4 transport sequence
5 conveyor belt
6 sorting device
7 scanning device
8 control unit
9 conveyor belt
10 sorting sequence
11 robots
12 transport unit
13 sensor
14 person
15 utility vehicle

1) A method for redistributing packages in a sorting station,
in which the packages are scanned successively in at least one transport sequence in order to respectively detect at least one sorting parameter in accordance with the at least one transport sequence,
in which the scanned packages are sorted in the at least one transport sequence in a sorting device on the basis of the at least one sorting parameter and are divided into at least two parallel sorting sequences of packages,
in which the packages of the parallel sorting sequences are loaded one after the other into at least one transport unit with at least one common robot in accordance with the sorting parameters,
in which a control device determines an optimized loading sequence for the at least one common robot based on the at least one sorting parameter of the packages of the at least two parallel sorting sequences and, preferably, based on at least one loading state of the at least one transport unit, and
in which the packages are loaded into the at least one transport unit by the at least one common robot in accordance with the optimized loading sequence.

2) The method according to claim 1,
in which the packages of separate parallel sorting sequences are successively loaded respectively into at least one different transport unit by at least one common robot in accordance with the sorting parameters of the packages of the separate parallel sorting sequences respectively.

3) The method according to claim 1,
in which the loading state of the at least one transport unit during the loading of the packages is determined by means of at least one, in particular optical, sensor and is passed to the control device for optimization of the loading sequence.

4) The method according to claim 1,
in which the at least one sorting parameter of the packages is scanned by means of a scanning device, in particular an optical scanning device, preferably by means of a six-sided scanner and/or a line scanner, in particular an RGB line scanner and/or a volume scanner.

5) The method according to claim 1,
in which the at least one sorting parameter of the packages is at least one size parameter of the packages, and
in which, preferably, at least two, in particular at least three, size parameters of each package, one, in particular maximum, height, one, in particular maximum, length and/or one, in particular maximum, width of the packages are scanned.

6) The method according to claim 1,
in which the control device determines, based on the at least one size parameter, the shape and/or the surface of the packages, whether the shape is at least one predetermined special shape of the packages, and
in which, preferably, packages with specific size parameters, shapes and/or surfaces are sorted into separate sorting sequences.

7) The method according to claim 5,
in which electronic 3D models of the packages are generated by the control device based on the at least one size parameter, the shape and/or the surface of the packages, and
in which the control device assigns the packages to different sorting sequences at least also based on the electronic 3D models of the packages.

8) The method according to claim 1,
in which the at least one sorting parameter of the packages is at least one weight of the packages and
in which, preferably, packages of a certain weight are sorted into separate sorting sequences.

9) The method according to claim 1,
in which the control device infers, based on the at least one size parameter, the shape, the surface and/or the weight of the packages, article classes of the packages, and
in which the control device assigns the packages to different sorting sequences at least also on the basis of the article classes of the packages.

10) The method according to claim 9,
in which at least one article class of the packages comprises packages unhandleable by the at least one common robot, and
in which, preferably, the packages of the at least one sorting sequence which are unhandleable by the at least one common robot are loaded by hand into at least one transport unit.

11) The method according to claim 1,
in which the common robot removes successively, in particular respectively the foremost packages from different sorting sequences of the at least two parallel sorting sequences for loading into the at least one transport unit, and
in which, preferably, the loading sequence is predetermined by the control device based on the at least one sorting parameter and the at least two parallel sorting sequences and/or on the basis of the at least one sorting parameter and the at least two parallel sorting sequences by the control device, which package of the loading sequence is loaded into which of a plurality of transport units.

12) The method according to claim 11,
in which the control device specifies the loading sequence of the packages at least partially with regard to a space-saving loading of the packages into the at least one transport unit.

13) The method according to claim 12,
in which the control device specifies the loading sequence of the packages at least partially with regard to the stackability of the packages in the at least one transport unit, and
in which, preferably, the stackability of the packages is estimated by the control device based on of the weight, the dimensional stability and/or the durability of the packages, in particular based on the at least one sorting parameter.

14) The method according to claim 1,
in which the packages are unloaded to form the at least one transport sequence from transport units in the form of commercial vehicle bodies, preferably box bodies, in particular of a truck, trailer or semi-trailer and/or from transport units in the form of non-self-propelled low-floor vehicles, in particular in the form of trolleys, lattice boxes or ULDs and/or
in which the packages are loaded by the at least one common robot into at least one utility vehicle and/or a non-self-propelled low-floor vehicle, in particular in the form of a trolley, a lattice box or a ULD.

15) The method according to claim 1
in which packages are packaged piece goods, in particular piece goods packaged in a cardboard box, bags, pouches, sacks and/or envelopes.
